(19) United States
(12) Patent Application Publication
(10) Pub. No.: US 2025/0229733 A1
(43) Pub. Date: Jul. 17, 2025

(54) GROMMET AND WIRE HARNESS

(71) Applicant: yazaki Corporation, Tokyo (JP)

(72) Inventor: Yoshinori Takahashi, Tochigi (JP)

(21) Appl. No.: 19/020,536

(22) Filed: Jan. 14, 2025

(30) Foreign Application Priority Data
Jan. 16, 2024 (JP) 2024-004288

(51) Int. Cl. B60R 16/02; H02G 3/22

(52) U.S. Cl. CPC B60R 16/0222; H02G 3/22

(57) ABSTRACT

A grommet includes: a main body unit into which a routing material can be inserted along an axial direction; and an accommodating unit that protrudes out from one end portion of the main body unit in the axial direction, that formed toward a first branching direction and a second branching direction intersecting with the axial direction and being different from each other, and that accommodates a branch unit of the routing material. The accommodating unit includes a lid-like unit that enables opening and closing of a slit formed from a first opening end to a second opening end and is formed to cover the branch unit in a state where the slit is closed in the accommodated state. The lid-like unit has a locking hole locked to a locking protrusion provided on the main body unit.

### CROSS-REFERENCE TO RELATED APPLICATION(S)

The present application claims priority to and incorporates by reference the entire contents of Japanese Patent Application No. 2024-004288 filed in Japan on Jan. 16, 2024.

### BACKGROUND OF THE INVENTION

### 1. Field of the Invention

The present invention relates to a grommet and a wire harness.

### 2. Description of the Related Art

In the conventional grommet, that in which an assembly work is easy while securing the waterproof property of the branch unit of the routing material is provided (see e.g., Japanese Patent Application Laid-open No. 2018-46616).

By the way, in the conventional grommet, the tape winding work is not performed because it is difficult to wind the tape around the central part of the lid-like unit covering the branch unit of the routing material. On the other hand, there is a possibility that, for example, the central part of the lid-like unit that is not wound with tape slightly opens during the routing operation of the wire harness, and the branch unit of the routing material is exposed to the outside, and thus there is room for improvement.

### SUMMARY OF THE INVENTION

An object of the present invention is to provide a grommet and a wire harness capable of appropriately preventing exposure of a branch unit of a routing material to the outside.

In order to achieve the above mentioned object, a grommet according to one aspect of the present invention includes a main body unit which is fitted into a through hole penetrating an attachment target along an axial direction to water stop the through hole, and into which a routing material is insertable along the axial direction; and an accommodating unit which protrudes out from one end portion of the main body unit in the axial direction, is formed toward two directions intersecting with the axial direction and different from each other, and accommodates a branch unit of the routing material, wherein the accommodating unit includes: a first opening end from which a first routing material branching to one of the two directions from the branch unit is led out in an accommodated state in which the accommodating unit accommodates the branch unit; a second opening end from which a second routing material branching to the other of the two directions from the branch unit is led out in the accommodated state; and a lid-like unit that enables opening and closing of a slit formed from the first opening end to the second opening end, and is formed so as to cover the branch unit in a state where the slit is closed in the accommodated state, and the lid-like unit includes a locking hole locked with respect to a locking protrusion provided on the main body unit.

The above and other objects, features, advantages and technical and industrial significance of this invention will be better understood by reading the following detailed description of presently preferred embodiments of the invention, when considered in connection with the accompanying drawings.

### BRIEF DESCRIPTION OF THE DRAWINGS

FIG. 1 is a perspective view illustrating a schematic configuration of a grommet and a wire harness according to an embodiment;

FIG. 2 is a perspective view illustrating a schematic configuration of the grommet according to the embodiment;

FIG. 3 is a partially enlarged view illustrating a schematic configuration of a locking structure of a lid-like unit in the grommet according to the embodiment;

FIG. 4 is a perspective view illustrating a schematic configuration of a grommet according to a modified example of the embodiment;

FIG. 5 is a perspective view illustrating a schematic configuration of a locking structure of a lid-like unit in the grommet according to the modified example of the embodiment; and

FIG. 6 is a perspective view illustrating a temporary locked state of the lid-like unit in the grommet according to the modified example of the embodiment.

### DETAILED DESCRIPTION OF THE PREFERRED EMBODIMENTS

Hereinafter, an embodiment according to the present invention will be described in detail with reference to the drawings. Note that the present invention is not limited by the following embodiments. That is, constituent elements in the following embodiments include those that can be easily assumed by those skilled in the art or those that are substantially the same, and various omissions, substitutions, and changes can be made without departing from the gist of the invention.

### Embodiment

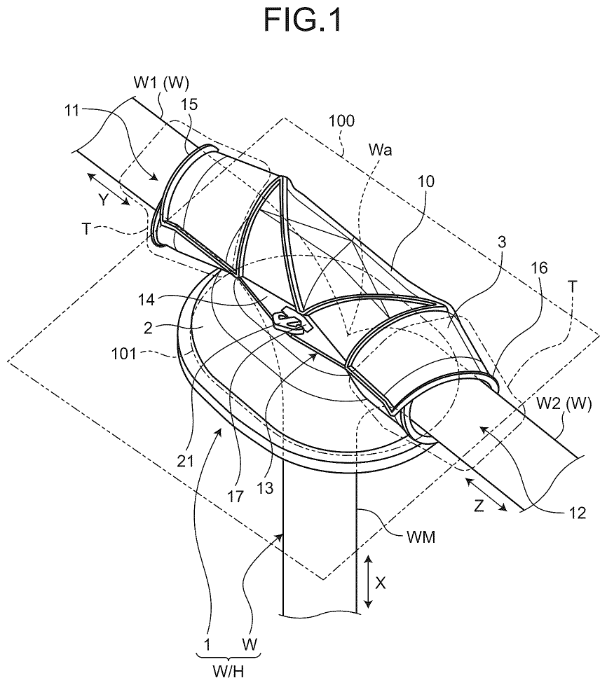

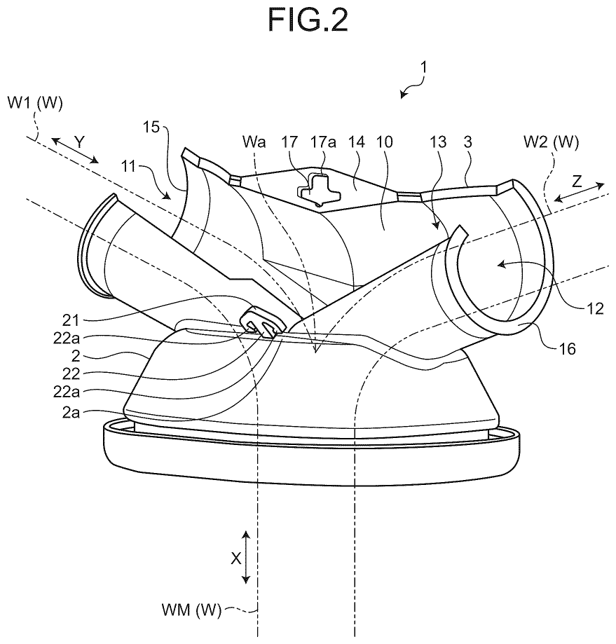

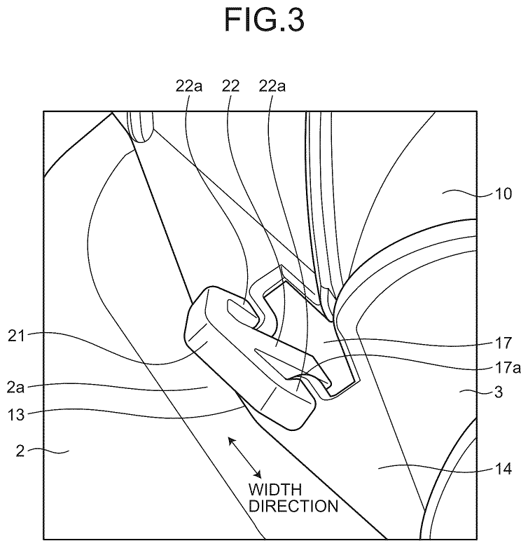

FIG. 1 is a perspective view illustrating a schematic configuration of a grommet and a wire harness according to an embodiment. FIG. 2 is a perspective view illustrating a schematic configuration of the grommet according to the embodiment. FIG. 3 is a partially enlarged view illustrating a schematic configuration of a locking structure of a lid-like unit in the grommet according to the embodiment.

As illustrated in FIGS. 1, 2, and 3, a grommet 1 of the present embodiment is incorporated in a wire harness WH routed in a vehicle or the like. Here, for example, the wire harness WH is configured such that a plurality of routing materials W used for power supply and signal communication are bundled to form a collective component for connection between devices mounted on a vehicle, and the plurality of routing materials W are connected to each device by a connector or the like. The wire harness WH includes a routing material W having conductivity and a grommet 1 provided in the routing material W and through which the routing material W is inserted. The wire harness WH may further include various components such as a corrugated tube, a resin tape, an exterior member such as a protector, an electrical connection box, and a fixing tool.

Note that in the following description, for the sake of convenience, among the X direction, the Y direction, and the Z direction in the drawing, the X direction is referred to as an “axial direction X”, the Y direction is referred to as a “first branching direction Y”, and the Z direction is referred to as a “second branching direction Z”. The axial direction X, the first branching direction Y, and the second branching direction Z intersect with each other. The axial direction X corresponds to a plate thickness direction of the illustrated attachment panel 100, and corresponds to an insertion direction of the routing material W and the grommet 1 with respect to a through hole 101. It is assumed that the first branching direction Y and the second branching direction Z intersect with respect to the axial direction X and are not the same direction. The first branching direction Y and the second branching direction Z may be directions that lie along each other. Note that each direction used in the following description will be described as a direction in a state where the grommet 1 is assembled to the attachment panel 100 unless otherwise specified.

The routing material W is configured by, for example, an electric wire bundle obtained by bundling a plurality of electric wires. In the electric wire, an outer side of a conductor portion (core wire) made of a plurality of metallic wires having conductivity is covered with a covering unit having an insulating property. The routing material W has bendability and flexibility as a whole. The routing material W includes a trunk line WM, a branch unit Wa, a first routing material W1, and a second routing material W2.

The trunk line WM is a portion routed in one of two spaces defined with the attachment panel 100 illustrated in FIG. 1 as a boundary. The trunk line WM is led out to one space side from an opening (not illustrated) provided on one side in the axial direction X of the grommet 1. The trunk line WM is fixed to the grommet 1 by winding of a tape member (not illustrated).

The branch unit Wa is a portion obtained by branching the trunk line WM in two directions of the first branching direction Y and the second branching direction Z, and is accommodated inside the grommet 1.

The first routing material W1 is a portion that corresponds to a branch line with respect to the trunk line WM, that is formed to extend along the first branching direction Y from the branch unit Wa, and that is routed in the other of the two spaces defined with the attachment panel 100 as a boundary. The first routing material W1 is led out to the other space side from a first opening 11 provided on one side in the first branching direction Y of the grommet 1. A portion of the first routing material W1 led out from the first opening 11 is wound by the tape member T together with a part of the grommet 1. That is, in the grommet 1, the first routing material W1 is fixed to the grommet 1 by winding the tape member T from the first routing material W1 to the grommet 1 along both sides in the first branching direction Y with the first opening 11 as the center.

The second routing material W2 is a portion that corresponds to a branch line with respect to the trunk line WM, that is formed to extend along the second branching direction Z from the branch unit Wa, and that is routed in the other of the two spaces defined with the attachment panel 100 as a boundary. The second routing material W2 is led out to the other space side from a second opening 12 provided on one side in the second branching direction Z of the grommet 1. A portion of the second routing material W2 led out from the first opening 11 is wound by the tape member T together with a part of the grommet 1. That is, in the grommet 1, the second routing material W2 is fixed to the grommet 1 by winding the tape member T from the second routing material W2 to the grommet 1 along both sides in the second branching direction Z with the second opening 12 as the center.

The grommet 1 is applied to the through hole 101 when routing the routing material W across two spaces defined with the attachment panel 100 as a boundary via the through hole 101 formed in the attachment panel 100 which is an attachment target. The attachment panel 100 is, for example, a metal plate constituting a body or the like of a vehicle, and the through hole 101 penetrates through the attachment panel 100 along the plate thickness direction. The two spaces defined with the attachment panel 100 as a boundary are typically an interior space (e.g., a cabin) and an exterior space (e.g., an engine compartment). The grommet 1 is assembled to the through hole 101 in a state in which the routing material W of the wire harness WH is inserted and exteriorly mounted around the routing material W, thereby protecting the routing material W passing through the through hole 101 and water-stopping (waterproofing) the through hole 101. The grommet 1 also has functions such as dustproof and sound insulation in addition to waterproofing of the through hole 101.

Specifically, as illustrated in FIGS. 1 and 2, the grommet 1 of the present embodiment is a seal member in which the routing material W is inserted therein along the axial direction X and water can be stopped between the grommet 1 and the through hole 101 of the attachment panel 100. The grommet 1 includes a main body unit 2 attached to the attachment panel 100 and an accommodating unit 3 that accommodates the branch unit Wa of the routing material W, and these are integrally formed as an elastic body. The grommet 1 is formed of, for example, an elastic resin material having insulating property (e.g., ethylene-propylene-diene rubber (EPDM) etc.) having low rigidity and high bendability, such as rubber or thermoplastic elastomer.

The main body unit 2 is a portion which is fitted into the through hole 101 penetrating the attachment panel 100 along the axial direction X to water stop the through hole 101, and into which the routing material W can be inserted along the axial direction X. The main body unit 2 is formed in a substantially tubular shape with the axial direction X as a center axis. The main body unit 2 includes a tubular space (not illustrated) extending in the axial direction X and through which the routing material W is inserted, and a locking protrusion 21.

As illustrated in FIGS. 1, 2, and 3, the locking protrusion 21 is a portion that is formed to protrude out from the main body unit 2 toward the outside and locks a lid-like unit 10 constituting the accommodating unit 3. The locking protrusion 21 is formed on a main body mating portion 2a provided on the accommodating unit 3 side in the axial direction X of the main body unit 2. The locking protrusion 21 has a locking unit 22 to be locked to a locking hole 17. The locking unit 22 is inserted into the locking hole 17 formed in the lid-like unit 10 of the accommodating unit 3, and is locked to the locking hole 17 to fix the lid-like unit 10 constituting the accommodating unit 3 to the main body unit 2. The locking unit 22 is fitted on an inner side of a notch 17a provided in the locking hole 17 in a state of being inserted into the locking hole 17. The locking unit 22 has return portions 22a on both sides in the width direction of the locking protrusion 21 illustrated in FIG. 3.

Each of the pair of return portions 22a is formed so as to be folded back from the distal end in the extending direction of the locking unit 22 toward the main body mating portion 2a side. As illustrated in FIG. 3, each of the pair of return portions 22a sandwiches a locking hole forming unit 14 formed in the lid-like unit 10 of the accommodating unit 3 between the distal end on the main body mating portion 2a side in the extending direction of the locking unit 22 and the main body mating portion 2a in a state where the locking protrusion 21 is fitted into the notch 17a of the locking hole 17.

A part or the whole of the surface of the main body mating portion 2a is a portion that faces and comes into contact with the locking hole forming unit 14 formed in the lid-like unit 10 of the accommodating unit 3 in the accommodated state in which the accommodating unit 3 accommodates the branch unit Wa of the routing material W. Here, the accommodated state means a state in which the trunk line WM is inserted into the main body unit 2 and the branch unit Wa is accommodated in the accommodating unit 3 as illustrated in FIGS. 1 and 2. The main body mating portion 2a is formed on the main body unit 2 side between the main body unit 2 and the accommodating unit 3.

The accommodating unit 3 is a portion that protrudes out from one end portion of the main body unit 2 in the axial direction X, that is formed toward the first branching direction Y and the second branching direction Z intersect with the axial direction X different from each other, and that accommodates the branch unit Wa of the routing material W. The accommodating unit 3 includes the lid-like unit 10, the first opening 11, the second opening 12, a slit 13, the locking hole forming unit 14, a first opening end 15, a second opening end 16, and the locking hole 17.

The lid-like unit 10 is a portion that allows the slit 13 formed from the first opening end 15 to the second opening end 16 to be opened and closed, and that is formed such that the lid-like unit 10 covers the branch unit Wa in a state where the slit 13 is closed in the accommodated state in which the accommodating unit 3 accommodates the branch unit Wa through the slit 13. The lid-like unit 10 is formed in a substantially tubular shape from one side in the first branching direction Y toward the other side in the second branching direction Z in a state where the slit 13 is closed. In a state where the slit 13 is closed, one end portion in the circumferential direction of the lid-like unit 10 is coupled to the main body unit 2, and the other end portion is separated from the main body unit 2 to form the slit 13. The lid-like unit 10 is fixed to the main body unit 2 by locking the locking hole 17 and the locking protrusion 21 in a state where the slit 13 is closed.

The first opening 11 is a portion that opens toward the first branching direction Y side when the slit 13 is in the closed state. The first opening 11 is formed at one end portion in the first branching direction Y when the locking hole 17 of the lid-like unit 10 is locked to the locking protrusion 21 of the main body unit 2 and the lid-like unit 10 is in the closed state. The first opening 11 has the first opening end 15. The first opening end 15 is formed in an annular shape when viewed from one side in the first branching direction Y. The first opening end 15 becomes non-annular due to the slit 13 in a state where the slit 13 is opened. In the first opening 11, the first routing material W1 is accommodated on the inner side via the slit 13 in a state where the first opening end 15 is non-annular, and the periphery of the first opening 11 is wound by the tape member T together with the first routing material W1 in a state where the first opening end 15 is annular.

The second opening 12 is a portion that opens toward the second branching direction Z side when the slit 13 is in the closed state. The second opening 12 is formed at one end portion in the second branching direction Z when the locking hole 17 of the lid-like unit 10 is locked to the locking protrusion 21 of the main body unit 2 and the lid-like unit 10 is in the closed state. The second opening 12 has the second opening end 16. The second opening end 16 is formed in an annular shape when viewed from one side in the second branching direction Z. The second opening end 16 becomes non-annular due to the slit 13 in a state where the slit 13 is opened. In the second opening 12, the second routing material W2 is accommodated on the inner side via the slit 13 in a state where the second opening end 16 is non-annular, and the periphery of the second opening 12 is wound by the tape member T together with the second routing material W2 in a state where the second opening end 16 is annular.

The slit 13 is formed from the first opening end 15 to the second opening end 16. The slit 13 is formed to be openable and closable by elastic deformation of the lid-like unit 10, and in the open state, the first routing material W1, the second routing material W2, and the branch unit Wa can pass through the routing material W.

The locking hole forming unit 14 is formed in the lid-like unit 10 and forms a part of the opening end of the slit 13. The locking hole forming unit 14 is formed in a flat plate shape and has a constant width along the extending direction of the slit 13. The locking hole forming unit 14 is formed so as to face and come into contact with the main body mating portion 2a of the main body unit 2 in a state where the slit 13 is closed. In the locking hole forming unit 14, a locking hole 17 is formed at a substantially central part in the extending direction of the lid-like unit 10. Here, the extending direction of the lid-like unit 10 is a direction along the extending direction of the slit 13.

The locking hole 17 constitutes a locking structure together with the locking protrusion 21, and the lid-like unit 10 is fixed to the main body unit 2 side by locking the locking hole 17 with the locking protrusion 21. The locking hole 17 is formed in a substantially rectangular shape in accordance with the shape of the locking protrusion 21 as viewed from the extending direction of the locking protrusion 21, and has a notch 17a on the slit 13 side. The notch 17a is formed to be recessed toward the slit 13 side in the locking hole forming unit 14. The notch 17a is a portion to which the locking unit 22 is fitted in a locked state where the locking hole 17 is locked with respect to the locking protrusion 21.

In the grommet 1 and the wire harness W/H of the present embodiment, the lid-like unit 10 formed so as to be able to open and close the slit 13 has the locking hole 17 formed in a substantially central part in the extending direction of the lid-like unit 10, and the main body unit 2 has the locking protrusion 21 at a position facing the locking hole 17 in a state where the slit 13 is closed. As a result, in the grommet 1 and the wire harness W/H, for example, when assembling the routing material W to the grommet 1, the assembly worker locks the locking hole 17 to the locking protrusion 21, whereby the lid-like unit 10 is fixed to the main body unit 2 side, and the closed state of the slit 13 can be maintained without winding the tape around the substantially central part in the extending direction of the lid-like unit 10.

As described above, the grommet 1 and the wire harness W/H according to the present embodiment include the accommodating unit 3 that are formed from the main body unit 2 through which the routing material W is inserted toward each of the first branching direction Y and the second branching direction Z, and accommodates the branch unit Wa of the routing material W. The accommodating unit 3 has a lid-like unit 10 that is formed of an elastic member capable of opening and closing the slit 13 formed from the first opening end 15 to the second opening end 16, and formed so as to cover the branch unit Wa in a state where the slit 13 is closed in the accommodated state. The lid-like unit 10 has the locking hole 17 locked to a locking protrusion 21 provided on the main body unit 2.

With the above configuration, the grommet 1 and the wire harness W/H according to the present embodiment can lock the substantially central part in the extending direction of the lid-like unit 10, which is difficult to wind the tape, to the main body unit 2. As a result, the grommet 1 and the wire harness W/H can prevent the branch unit Wa of the routing material W from being exposed or jumping out to the outside due to the opening of the slit 13 of the lid-like unit 10 even though the peripheries of the first opening 11 and the second opening 12 are fixed by the tape member T, for example, during the packing of the wire harness W/H or the routing task of the wire harness W/H. In addition, with the above configuration, the grommet 1 and the wire harness W/H can maintain the closed state of the slit 13, and the sealing degree of the grommet 1 located between two spaces defined with the attachment panel 100 as a boundary can be improved. As a result, in the grommet 1 and the wire harness W/H, the slit is not easily opened by the locking structure provided in the main body unit 2 and the lid-like unit 10 of the grommet 1, and the sound insulation property and the soundproofing property of the grommet 1 attached to the through hole 101 of the attachment panel 100 can be improved.

Furthermore, in the grommet 1 and the wire harness W/H, the locking hole 17 has the notch 17a formed to be recessed toward the slit 13 side, and the locking unit 22 has the pair of return portions 22a. As a result, in the grommet 1 and the wire harness W/H, in the locked state where the locking hole 17 is locked to the locking protrusion 21, the locking unit 22 is fitted into the notch 17a so that the locking hole forming unit 14 is sandwiched between the pair of return portions 22a and the main body mating portion 2a, and it becomes easy to maintain the closed state of the slit 13.

In addition, the grommet 1 and the wire harness W/H have a locking hole forming unit 14 formed in the lid-like unit 10 and formed in a flat plate shape that forms a part of the opening end of the slit 13, and the locking hole forming unit 14 has a locking hole 17 formed in a substantially central part in the extending direction of the lid-like unit 10. As a result, the grommet 1 and the wire harness W/H allow the assembly worker to pinch the locking hole forming unit 14, for example, when assembling the routing material W to the grommet 1. The assembly worker can easily open and close the slit 13 by closing or opening the lid-like unit 10 while pinching the locking hole forming unit 14.

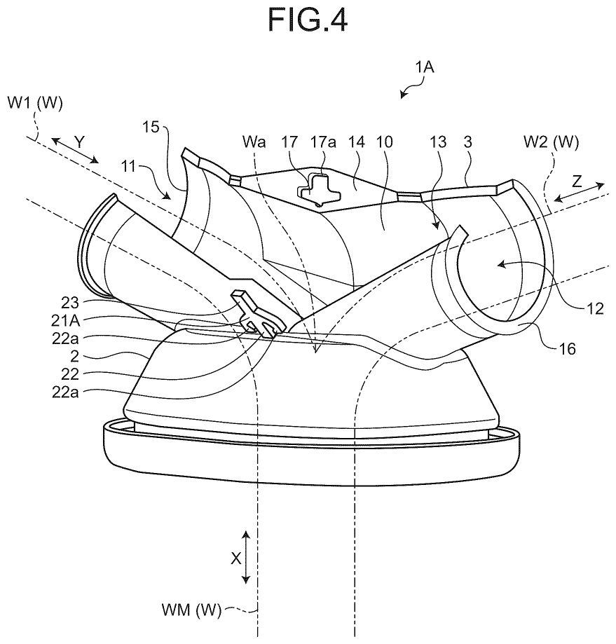

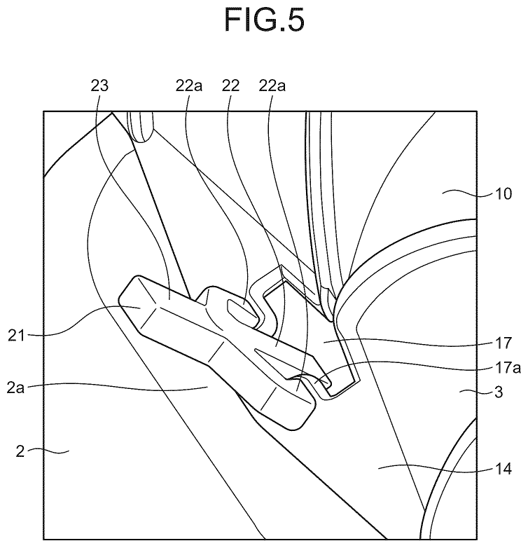

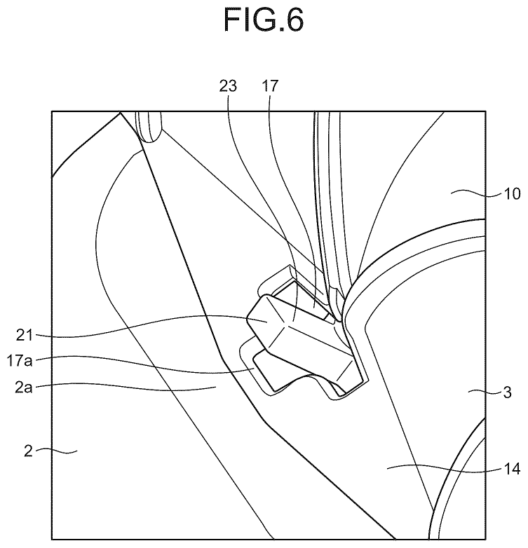

Next, a grommet 1A and a wire harness W/H according to a modified example of the embodiment will be described. FIG. 4 is a perspective view illustrating a schematic configuration of a grommet according to a modified example of the embodiment. FIG. 5 is a perspective view illustrating a schematic configuration of a locking structure of a lid-like unit in the grommet according to the modified example of the embodiment. FIG. 6 is a perspective view illustrating a temporary locked state of the lid-like unit in the grommet according to the modified example of the embodiment.

As illustrated in FIGS. 4, 5, and 6, the grommet 1A according to a modified example is different from the grommet 1 in that a locking protrusion 21A includes a rib 23. The locking protrusion 21A will be described below. The locking protrusion 21A includes the locking unit 22 and the rib 23. The rib 23 is formed to extend from the locking unit 22 in the extending direction of the locking protrusion 21A or the locking unit 22, and is located on the distal end side in the extending direction of the locking unit 22. The rib 23 is formed to be insertable with respect to the locking hole 17 prior to the locking unit 22. Specifically, as illustrated in FIG. 6, when locking to the locking hole 17 with respect to the locking protrusion 21, the rib 23 is inserted into the locking hole 17 before the locking unit 22 is inserted into the locking hole 17.

In the grommet 1A and the wire harness W/H according to the modified example, since the rib 23 is provided toward the outer side than the locking unit 22 in the locking protrusion 21A, as illustrated in FIG. 6, the rib 23 protrudes out from the locking hole 17 beyond the locking unit 22. As a result, in the grommet 1A and the wire harness W/H, for example, when assembling the routing material W to the grommet 1A, the assembly worker can pinch the rib 23 protruding out from the locking hole 17 beyond the locking unit 22. Then, the assembly worker pulls the rib 23 while picking up the rib, so that the entire locking protrusion 21A is elastically deformed in the extending direction of the locking unit 22, the pair of return portions 22a of the locking unit 22 contracts in the width direction of the locking unit 22, and the locking unit 22 can easily pass through the locking hole 17.

As described above, in the grommet 1A and the wire harness W/H according to the modified example of the present embodiment, the locking unit 22 is easily locked to the locking hole 17 by the assembly worker inserting the rib 23 into the locking hole 17 and pinching and pulling the rib 23, and hence the load of the locking work of the lid-like unit 10 by the assembly worker can be reduced.

In the above embodiment and modified example, the first branching direction Y and the second branching direction Z intersect with respect to the axial direction X and are not in the same direction with each other, but, the present invention is not limited thereto, and the first branching direction Y and the second branching direction Z may be in the same direction.

According to the grommet and the wire harness of the present embodiment, an effect can be obtained in that exposure of the branch unit of the routing material accommodated in the grommet to the outside can be appropriately prevented.

Although the invention has been described with respect to specific embodiments for a complete and clear disclosure, the appended claims are not to be thus limited but are to be construed as embodying all modifications and alternative constructions that may occur to one skilled in the art that fairly fall within the basic teaching herein set forth.

What is claimed is:

1. A grommet comprising:
a main body unit which is fitted into a through hole penetrating an attachment target along an axial direction to water stop the through hole, and into which a routing material is insertable along the axial direction; and
an accommodating unit which protrudes out from one end portion of the main body unit in the axial direction, is formed toward two directions intersecting with the axial direction and different from each other, and accommodates a branch unit of the routing material, wherein
the accommodating unit includes:
a first opening end from which a first routing material branching to one of the two directions from the branch unit is led out in an accommodated state in which the accommodating unit accommodates the branch unit;
a second opening end from which a second routing material branching to the other of the two directions from the branch unit is led out in the accommodated state; and
a lid-like unit that enables opening and closing of a slit formed from the first opening end to the second opening end, and is formed so as to cover the branch unit in a state where the slit is closed in the accommodated state, and
the lid-like unit includes a locking hole locked with respect to a locking protrusion provided on the main body unit.

2. The grommet according to claim 1, wherein the locking protrusion includes:
a locking unit locked to the locking hole; and
a rib formed to extend in an extending direction of the locking protrusion from the locking unit, the rib being insertable into the locking hole prior to the locking unit.

3. A wire harness comprising:
a routing material having conductivity; and
a grommet provided on the routing material, wherein
the grommet includes:
a main body unit which is fitted into a through hole penetrating an attachment target along an axial direction to water stop the through hole, and into which a routing material is insertable along the axial direction; and
an accommodating unit which protrudes out from one end portion of the main body unit in the axial direction, is formed toward two directions intersecting with the axial direction and different from each other, and accommodates a branch unit of the routing material,
the accommodating unit includes:
a first opening end from which a first routing material branching to one of the two directions from the branch unit is led out in an accommodated state in which the accommodating unit accommodates the branch unit;
a second opening end from which a second routing material branching to the other of the two directions from the branch unit is led out in the accommodated state; and
a lid-like unit that enables opening and closing of a slit formed from the first opening end to the second opening end, and is formed so as to cover the branch unit in a state where the slit is closed in the accommodated state, and
the lid-like unit includes a locking hole locked with respect to a locking protrusion provided on the main body unit.
